(19) United States
(12) Patent Application Publication
(10) Pub. No.: US 2004/0177510 A1
(43) Pub. Date: Sep. 16, 2004

(54) Apparatus and method for dispensing a shaving aid onto a user's skin during a shaving operation

(75) Inventor: Andrew J. Pennella, Stamford, CT (US)

Correspondence Address: Richard R. Michaud, McCormick, Paulding & Huber LLP, CityPlace II, 185 Asylum Street, Hartford, CT, 06103, US

(73) Assignee: Eveready Battery Company, Inc., Westlake, OH

(21) Appl. No.: 10/777,988

(22) Filed: Feb. 11, 2004

Related U.S. Application Data
(60) Provisional application No. 60/446,863, filed on Feb. 12, 2003.

(51) Int. Cl. B26B 19/44

(52) U.S. Cl. 30/41

(57) ABSTRACT

In a razor including a shaving aid applicator, a reservoir is coupled to a razor body and defines an interior area adapted to retain a quantity of shaving aid therein. An actuator associated with the reservoir is movable between a non-dispensing and dispensing position to selectively cause an amount of shaving aid contained in said interior area to flow therefrom. At least one discharge opening is associated with the razor body to allow the shaving aid to flow therefrom onto a user's skin during a shaving operation.

### CROSS-REFERENCE TO RELATED APPLICATIONS

This application is entitled to the benefit of and incorporates by reference essential subject matter disclosed in Provisional Patent Application No. 60/446,863 filed on Feb. 12, 2003.

### FIELD OF THE INVENTION

The present invention is generally related to razors used in shaving operations, and is more specifically directed to a razor incorporating a shaving aid dispenser.

### BACKGROUND OF THE INVENTION

As used herein, the term “shaving aid” is to be broadly construed to include shaving creams, soaps, gels, and foams, as well as any other pre-shaving or post-shaving skin preparations, such as, but not limited to, lotions, aftershaves, perfumes, balms, or other medicinal skin applications.

Shaving aids are usually applied either pre- or post-shaving for various reasons. For example, shaving soap, gel, cream, or foam is almost always applied by a user prior to a shaving operation to soften the hair to be cut and to lubricate the skin. Lotions, balms, and other medicinal skin applications are often applied to relieve irritation caused by shaving. Perfumes and other scented aftershaves can usually be applied post-shaving.

In all instances where a shaving aid is used, a separate container, usually the container the shaving aid was purchased in, must be on hand. Moreover, where the user travels, these containers must be carried from place to place where they can be forgotten. These containers can be heavy, and, in the case of aftershaves and perfumes, are often made of glass which is subject to shatter.

Based on the foregoing, it is the general object of the present invention to provide a compact, lightweight, shatterproof convenient manner in which to store, transport and apply a shaving aid.

### SUMMARY OF THE PRESENT INVENTION

The present invention is directed in one aspect to a razor having a razor body with a shaving aid applicator coupled thereto. The shaving aid applicator includes reservoir means defining an interior area adapted to retain a quantity of shaving aid therein. Actuating means are also provided for selectively causing a portion of the shaving aid to flow out of the interior area upon movement of the actuating means between a non-dispensing and a dispensing position. When the actuating means are moved to the dispensing portion, dispensing means facilitate the transference of the shaving aid from the reservoir means onto a user's skin.

In the preferred embodiment of the present invention, the reservoir means includes a receptacle integral with the razor body, and the actuator means includes a manually depressible button sealingly coupled to the receptacle so that repeated movement of the button between the non-dispensing and the dispensing positions causes an increase of pressure within the interior area, thereby forcing a portion of the shaving aid residing therein to flow from the dispensing means onto the user's skin. However, the present invention is not limited in this regard as the shaving aid can also be stored in the interior area under pressure.

When the interior area of the receptacle is pressurized, a check valve is provided and extends from an outer surface of the receptacle and is in fluid communication with the interior area. The quantity of pressurized shaving aid in the receptacle can be replenished through the check valve from a likewise pressurized source of shaving aid. Where the receptacle is not pressurized, the shaving aid can be replenished through an aperture extending form the outer surface into the interior area. Once replenished a cap or plug sealingly engages the aperture, thereby retaining the shaving aid therein.

The dispensing means can assume various different forms and can be positioned at various locations on the razor. For example, the dispensing means can take the form of a discharge nozzle or array of apertures, preceding or following the razor cartridge mounted on the razor body. The dispensing means can also be located between the blades of a multi-bladed razor cartridge.

In addition to the previously described button, the actuator means can also assume different forms. In one embodiment of the present invention, the actuator means includes a normally closed valve that can be moved to an open position via movement of the razor cartridge from an extended to a compressed position such as when the cartridge is pressed against a user's skin. When in the compressed position, the shaving aid flows through an outlet located on the razor cartridge.

The present invention also resides in a method for applying the shaving aid, using the above-described razor, to the user's skin during a shaving operation. As the razor, and thereby the razor cartridge, is drawn in a shaving direction across the user's skin, the actuator is manipulated into the above-described dispensing position, causing a quantity of the shaving aid onto selective areas of the user's skin.

### BRIEF DESCRIPTION OF THE DRAWINGS

FIG. 1 is a side elevational partly cross-sectional view of an embodiment of the razor of the present invention showing a reservoir containing a quantity of shaving aid, the reservoir being integral with the razor.

FIG. 2 is a side elevational partly cross-sectional view of the razor of FIG. 1 showing an aperture extending into the reservoir and a plug in the aperture, thereby allowing the shaving aid contained in the reservoir to be replenished.

FIG. 3 is a side elevational partly cross-sectional view of the razor of FIG. 1 showing a check valve extending into the reservoir, thereby allowing the shaving aid contained therein to be replenished under pressure.

FIG. 4 is a side elevational view of an alternate embodiment of the razor of FIG. 1 wherein the reservoir is removable.

FIG. 5 is a side elevational view of another embodiment of the razor of FIG. 1 showing a shaving aid dispensing nozzle following the razor cartridge.

FIG. 6 is a partial view of an alternate embodiment of the razor of FIG. 5 showing an array of discharge holes instead of a dispensing nozzle.

FIG. 7 is a side elevational partly cross-sectional view of still another embodiment of the razor of the present invention whereby shaving aid is dispensed between two blades of a multi-blade razor cartridge.

### DETAILED DESCRIPTION OF THE PREFERRED EMBODIMENTS

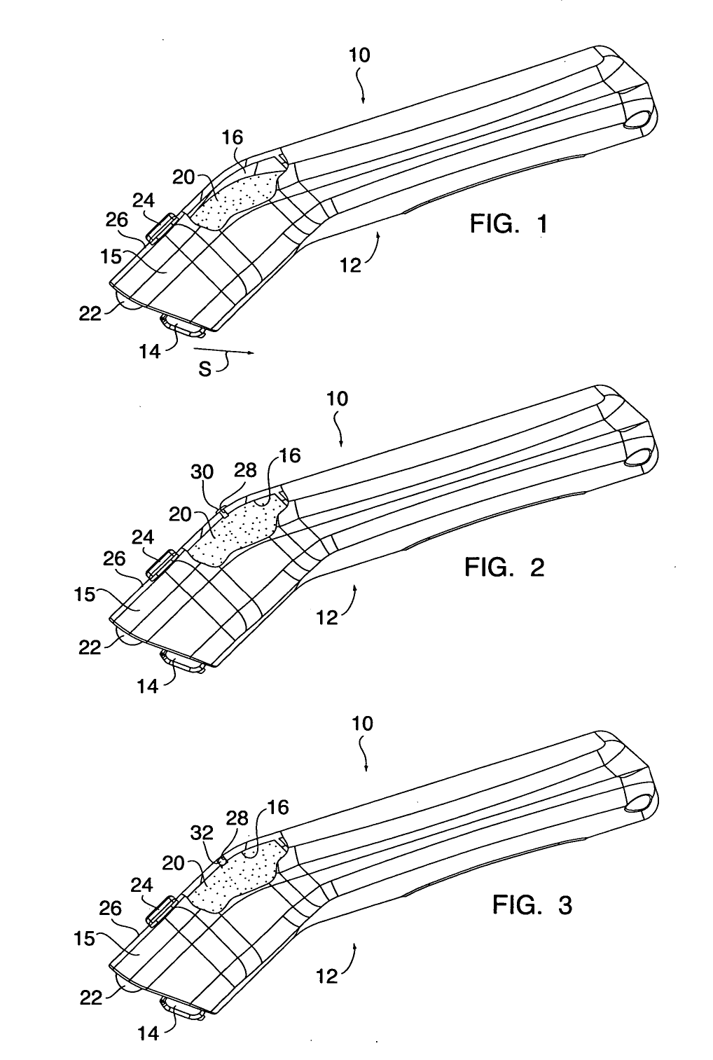

As shown in FIG. 1, a razor generally designated by the reference number 10 includes a razor body generally referred to by the reference number 12 upon which is attached a shaving cartridge 14 containing one or more blades (not shown). In the illustrated embodiment, the razor body 12 defines a reservoir 15 integral therewith and having an interior area 16 adapted to retain a quantity of shaving aid 20 therein. A discharge nozzle 22 extends outwardly from the razor body 12 adjacent to the razor cartridge 14. An actuator 24 is located on an outer surface 26 of the razor body 12 and is manually manipulable between a non-dispensing position and a dispensing position. When the actuator 24, shown in the illustrated embodiment as a button, is moved to the dispensing position, a quantity of the shaving aid 20 located in the interior area 16 is dispensed through the discharge nozzle 22.

The shaving aid 20 can assume any one of a number of different forms. For example, the shaving aid 20 can be a liquid, foam, gel, lotion, perfume or other medicinal skin application. In addition, the shaving aid 20 can reside in the interior area 16 at atmospheric pressure, or the shaving aid can be pressurized. If the shaving aid 20 is at atmospheric pressure, the actuator 24 and the nozzle 22 will function in much the same manner as the common non-aerosol pump bottles employed today. In other words the actuator 24 must be pumped between the non-dispensing and the dispensing positions, thereby causing pressure to build in the interior area 16 that in turn causes shaving aid 16 to be dispensed from the discharge nozzle 22.

Depending on several factors, amongst which is whether the above-described razor will be configured as a disposable razor or will incorporate means for releasably retaining disposable razor cartridges, the interior area can be pre-filled with shaving aid with no means for replenishing the shaving aid, or, as shown in FIG. 2, can be refillable.

Referring to FIG. 2, the reservoir 15 is defined in part by an exterior surface 26 that includes an aperture 28 extending therethrough and in fluid communication with the interior area 16. A cap or plug 30 is releasably and sealingly engageable with the aperture 28, thereby allowing the reservoir 16 to be refilled with shaving aid 20 upon removal of the plug. While a plug 30 frictionally engaged with the peripheral walls that define the aperture 28 has been shown and described, the present invention is not limited in this regard as other manners of releasably securing the plug within the aperture 28, such as by employing threads or a snap fit, can be substituted without departing from the broader aspects of the present invention. Moreover, the plug 30 can also be tethered to the reservoir 15, thereby preventing it from becoming lost.

As shown in FIG. 3, instead of a plug 30, a check valve 32 can be positioned in the aperture 28, thereby allowing the interior area 16 of the reservoir 15 as well as the shaving aid 20 resident therein to be pressurized. In the illustrated embodiment, the check valve 32 is shown schematically; however, the check valve is of the type adapted to mate with a pressurized container, in the instant situation, one containing shaving aid, such that the shaving aid can be transferred from the container to the interior area 16 of the reservoir 15 in much the same manner as a butane-type cigarette lighter is refilled. In a razor configured in this manner, the actuator 24 is in communication with the discharge nozzle 22 such that moving the actuator to the dispensing position will cause shaving aid 20 to flow under pressure through the discharge nozzle 22 so long as the actuator is held in the dispensing position.

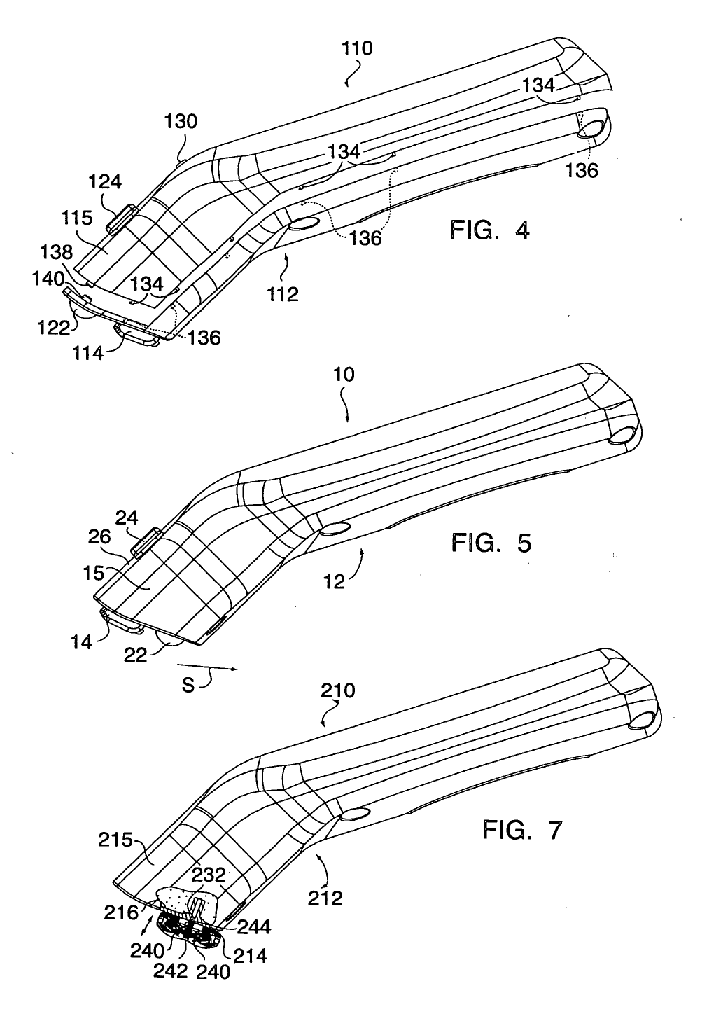

A second embodiment of the razor of the present invention, shown in FIG. 4, is generally designated by the reference numeral 110. The razor 110 is similar in many respects to the razor 10 described above, and therefore like reference numerals preceded by the number 1 are used to indicate like elements. The razor 110 differs from the razor 10 in that the reservoir 115 is detachable from the razor body 112. This allows a user to remove the reservoir 115 from the razor body 112 for easy refilling, or if the user employs different shaving aids, the user can have several reservoirs each filled with a different shaving aid. The reservoir 115 is shown in the illustrated embodiment incorporating a plug 130; however, the present invention is not limited in this regard as a check valve (as detailed above) or other type of closure known to those skilled in the pertinent art to which the present invention pertains, can be substituted.

Still referring to FIG. 4, the reservoir 115 includes tabs 134 that engage mating recesses 136 (shown in dotted lines) in the razor body, thereby releasably retaining the reservoir 115 thereon. The reservoir 115 includes an outlet 138 which retains the shaving aid in the interior area until the actuator 124 is moved from the non-dispensing to the dispensing position. The outlet 138 is adapted to sealingly mate with a portion 140 of the discharge nozzle 122 so that during operation, shaving aid can be transferred from the reservoir 115 and through the discharge nozzle 122. While tabs 134 and recesses 136 have been shown and described, the present invention is not limited in this regard as other means for mounting the reservoir to the razor body, such as via fasteners or adhesives, may be substituted without departing from the broader aspects of the present invention.

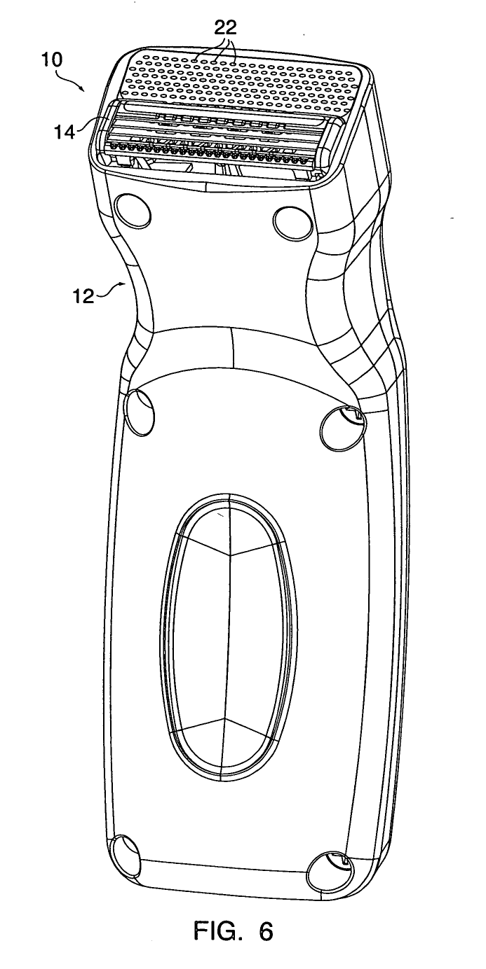

As shown in FIGS. 1, 5, and 6, the discharge nozzle 22 can be positioned in different locations relative to the razor cartridge 14. For example and as shown in FIG. 1, the discharge nozzle 22 trails the razor cartridge 14 when the razor 10 is moved along a user's skin in a shaving direction labeled “S”. Conversely, and as shown in FIG. 5, the discharge nozzle 22 can also be located so as to precede the razor cartridge 14 relative to the shaving direction “S”. In addition to the different nozzle locations illustrated in FIGS. 1 and 5, the nozzle 22 can also assume different configurations. For example, the nozzle could be formed from a single opening, or could be in the form of a plurality of individual apertures extending through the razor body into the interior area 16.

A third embodiment of the razor of the present invention, shown in FIG. 4, is generally designated by the reference numeral 210. The razor 210 is similar in many respects to the razor 10 described above, and therefore like reference numerals preceded by the number 2 are used to indicate like elements. The razor 210 differs from the razor 10 in that instead of the actuator 24 of FIG. 1 being in the form of a button, and the discharge nozzle 22 being positioned adjacent to the razor cartridge 14, the razor cartridge 214 itself forms part of the actuator. In the illustrated embodiment, the razor cartridge 214 includes a pair of razor blades 240 spaced apart relative to each other and defining a gap 242 therebetween. A shaving aid outlet 244 is positioned within the gap. A normally closed valve 232 is positioned between the outlet 244 and the interior area 216 of the reservoir 215. In the illustrated embodiment, the shaving cartridge 214 is movable between the above-described non-dispensing and dispensing positions.

Accordingly, during a shaving operation, pressure applied via the user pressing the razor cartridge against his or her skin causes the razor cartridge to move to the dispensing position. This in turn causes the normally closed valve 246 to open, resulting in the shaving aid 220 stored in the interior area 216 to flow out of the outlet 244 onto the user's skin. While a double-bladed razor cartridge 214 has been shown and described, the present invention is not limited in this regard as a razor cartridge employing a single razor blade with the outlet adjacent thereto, or multiple razor blades, can be substituted without departing from the broader aspects of the present invention.

While preferred embodiments have been shown and described, one skilled in the pertinent art to which the present invention pertains will immediately recognize that various modifications and substitutions may be made. Accordingly, it is to be understood that the present invention has been described by way of example, and not by limitation.

What is claimed is:

1. A razor including a shaving aid applicator comprising:
a razor body;
reservoir means coupled to said razor body, said reservoir means defining an interior area adapted to retain a quantity of shaving aid therein;
actuator means for selectively causing an amount of said shaving aid to flow out of said interior area upon movement between a non-dispensing position wherein said shaving aid is retained within said interior area, and a dispensing position whereby a portion of said quantity of shaving aid flows from said interior area; and
dispensing means for transferring said amount of shaving aid from said razor body onto a user's skin in response to movement of said actuator means to said dispensing position.

2. A razor including a shaving aid applicator as defined by claim 1, wherein said reservoir means includes a receptacle integral with said razor body.

3. A razor including a shaving aid applicator as defined by claim 2, wherein:
said actuator means includes a manually depressible button sealingly coupled to said receptacle so that repeated movement of said button between said non-dispensing and said dispensing positions causes an increase of pressure within said interior area, thereby forcing a portion of said shaving aid residing therein to flow from said dispensing means.

4. A razor including a shaving aid applicator as defined by claim 2, wherein said receptacle includes:
an aperture extending from an outer surface defined by said receptacle into said interior area;
a plug releasably and sealingly engageable with said aperture, said plug being movable between an open position wherein access is gained to said interior area via said aperture to allow said shaving aid receivable therein to be replenished, and a closed position wherein said shaving aid is held captive within said interior area.

5. A razor including a shaving aid applicator as defined by claim 1, wherein said shaving aid is in the form of a gel.

6. A razor including a shaving aid applicator as defined by claim 1, wherein said shaving aid is in the form of foam.

7. A razor including a shaving aid applicator as defined by claim 1, wherein said shaving aid is liquid.

8. A razor including a shaving aid applicator as defined by claim 1, wherein:
said shaving aid is receivable in said interior area under pressure, and said razor further comprises
a check valve extending through an outer wall defined by said reservoir means into said interior area, said check valve being adapted to engage a pressurized container of shaving aid to thereby allow the quantity of shaving aid in said interior area to be replenished under pressure.

9. A razor including a shaving aid applicator as defined by claim 1, wherein said dispensing means includes at least one nozzle coupled to the razor body for dispensing said shaving aid upon movement of said actuator means from said non-dispensing to said dispensing position.

10. A razor including a shaving aid applicator as defined by claim 9, wherein said nozzle precedes a razor cartridge coupled to said razor body and having at least one razor blade mounted thereon such that said shaving aid is dispensable from said nozzle onto an area of a user's skin prior to said at least one razor blade contacting said area.

11. A razor including a shaving aid applicator as defined by claim 9, wherein said nozzle follows a razor cartridge coupled to said razor body and having at least one razor blade mounted thereon such that said shaving aid is dispensable from said nozzle onto an area of a user's skin after said at least one razor blade passes over said area.

12. A razor including a shaving aid applicator as defined by claim 1, further comprising:
a razor cartridge having at least two razor blades mounted thereon, said razor blades being spaced apart relative to one another to define a gap therebetween;
said dispensing means including an outlet positioned in said gap for distributing said shaving aid between said at least two razor blades in response to movement of said actuator means from said non-dispensing to said dispensing position; and
means defining a path between, and in fluid communication with, said interior area and said outlet along which said shaving aid flows when said actuating means is in said dispensing position.

13. A razor including a shaving aid applicator as defined by claim 12, wherein:
said razor cartridge is movable relative to said razor body from an extended position to a compressed position in response to a force applied to said razor cartridge; and wherein
said actuator means includes a normally closed valve positioned in said razor body and in fluid communication with said interior area and said outlet, said valve being movable to an open position in response to said cartridge being in said compressed position.

14. A razor including a shaving aid applicator as defined by claim 1, wherein:
said reservoir means includes a receptacle releasably attachable to said razor body, said receptacle having an outlet engageable with said dispensing means;
said actuator means being positioned on said reservoir and in operative engagement with said outlet so that movement of said actuator means from said non-dispensing to said dispensing position causes said shaving aid to flow through said dispensing means onto the user's skin.

15. A method for applying a shaving aid to a user's skin during a shaving operation, comprising the steps of:
providing a razor having; a razor body, a razor cartridge having at least one razor blade mounted thereto, a reservoir containing a quantity of shaving aid therein coupled to the razor body, an actuator in communication with said reservoir for selectively causing an amount of said shaving aid to flow out of said reservoir upon movement of said actuator between a non-dispensing position wherein said shaving aid is retained within said interior area, and a dispensing position wherein said shaving aid is allowed to flow out of said reservoir; and dispensing means for transferring said amount of shaving aid onto a user's skin in response to movement of said actuating means to said dispensing position;
drawing said razor and thereby said at least one razor blade across a user's skin in a first shaving direction; and
moving said actuator between said non-dispensing and said dispensing positions while said razor blade is drawn across the user's skin to selectively apply a quantity of said shaving aid onto the user's skin.

16. A method as defined by claim 14, wherein said razor cartridge is releasably mounted to said razor body.
